(19) United States
(12) Patent Application Publication
(10) Pub. No.: US 2024/0144114 A1
(43) Pub. Date: May 2, 2024

(54) METHODS AND SYSTEMS FOR AUTOMATED IDENTIFICATION OF OPTIMIZABLE FACTORS IN MULTIVARIATE PROCESSES

(71) Applicant: DKS Data & Strategy, Inc., Cambridge, MA (US)

(72) Inventor: Daniel Shenfeld, Cambridge, MA (US)

(21) Appl. No.: 18/384,699

(22) Filed: Oct. 27, 2023

Related U.S. Application Data
(60) Provisional application No. 63/421,393, filed on Nov. 1, 2022.

(51) Int. Cl. G06Q 10/04

(52) U.S. Cl. CPC G06Q 10/04

(57) ABSTRACT

A method for automated identification of optimizable factors in multivariate processes includes receiving a first data set associated with a multivariate process. The method includes analyzing, by at least one machine learning engine, the first data set to determine at least one interaction between at least two factors in the multivariate process and at least one correlation associated with the interaction. The method includes identifying at least one factor to optimize to improve an execution of the multivariate process. The method includes generating a randomized controlled experiment to execute to determine whether optimizing the at least one identified factor improves execution of the multivariate process by an amount exceeding a threshold amount of improvement. The method includes identifying and acquiring a second data set needed to execute the experiment and executing the randomized controlled experiment. The method includes generating and providing a recommendation for optimizing the at least one factor.

### CROSS-REFERENCE TO RELATED APPLICATIONS

This application claims priority from U.S. Provisional Patent Application No. 63/421393 filed on Nov. 1, 2022, entitled “Methods and Systems for Automated Identification of Optimizable Factors in Multivariate Processes,” which is hereby incorporated by reference.

### BACKGROUND

The disclosure relates to methods for optimizing multivariate processes. More particularly, the methods and systems described herein relate to functionality for automated identification of optimizable factors in multivariate processes.

Conventionally, typical approaches to optimizing multivariate processes subject to constraints are incapable of identifying and optimizing factors that impact efficiency when the factors relate to interactions between steps of the process. Conventional approaches do not provide functionality for determining when optimizing a factor in a first part of a process will have downstream consequences for factors in subsequent parts of the process that impact or negate overall optimization. Additionally, typical attempts to optimize such processes fail to support optimization for processes with nondeterministic actors involved in the process but potentially out of control of the optimization system. Moreover, typical methods are not able to account for the variance among the plurality of actors, relying instead on averages alone. Furthermore, many systems in which multivariate processes execute depend upon access to data that is currently siloed into different data sources and which tend to require large engineering teams to attempt to centralize data and convert the data into a standard format that would allow for analysis in order to identify and optimize key inter-step factors. Therefore, many implementors of multivariate processes have expressed a long-felt need for data-driven approaches to optimization of such factors and in scenarios relying upon nondeterministic actors, but do not have any conventional systems that provide such functionality.

### BRIEF DESCRIPTION

In one aspect, a method for automated identification of optimizable factors in multivariate processes includes receiving a first data set associated with a multivariate process. The method includes analyzing, by at least one machine learning engine, the first data set to determine at least one interaction between at least two factors in the multivariate process and at least one correlation associated with the at least one interaction. The method includes identifying at least one factor to optimize to improve an execution of the multivariate process, responsive to the analyzing. The method includes generating a randomized controlled experiment to execute to determine whether optimizing the at least one identified factor improves the execution of the multivariate process by an amount exceeding a threshold amount of improvement. The method includes identifying a second data set needed to execute the randomized controlled experiment. The method includes acquiring the second data set. The method includes executing the randomized controlled experiment. The method includes generating a recommendation for optimizing the at least one factor. The method includes providing the recommendation.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a block diagram depicting an embodiment of a system for automated identification of optimizable factors in multivariate processes;

FIG. 2 is a flow diagram depicting an embodiment of a method for automated identification of optimizable factors in multivariate processes;

FIG. 3 is a flow diagram depicting an embodiment of a method for automated identification of optimizable factors in multivariate processes; and

FIGS. 4A-4C are block diagrams depicting embodiments of computers useful in connection with the methods and systems described herein.

### DETAILED DESCRIPTION

The methods and systems described herein may provide functionality for automated identification of optimizable factors in multivariate processes. In some embodiments, the methods and systems described herein provide functionality for quantifying factors that impact multiple steps in a process and for identifying consequences to subsequent steps based on modification of the quantified factors. The methods and systems described herein may further identify one or more data sets needing to be analyzed to determine whether or how to optimize a particular factor, gain access to such data sets, execute experiments (such as randomized controlled experiments) to generate a recommended optimization, and provide access to the generated recommendation.

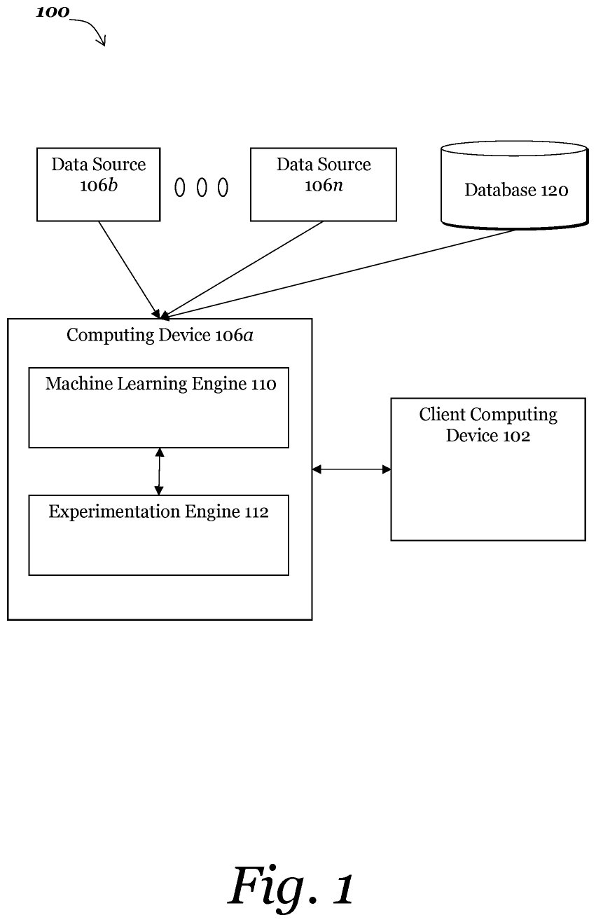

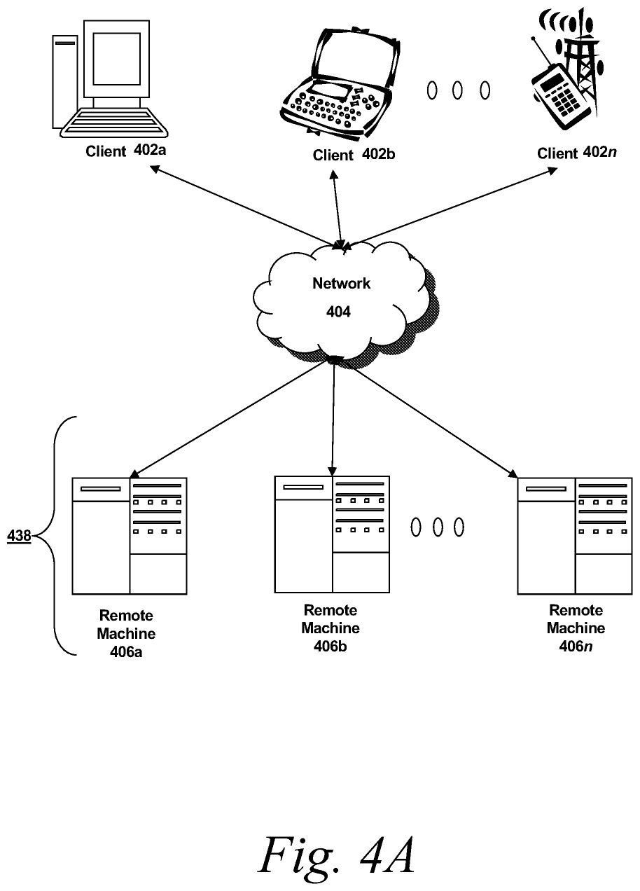

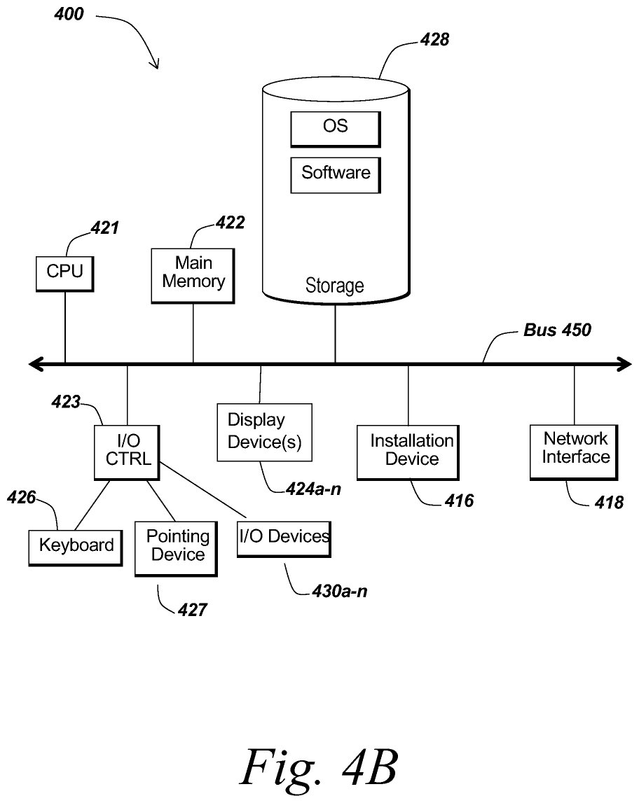

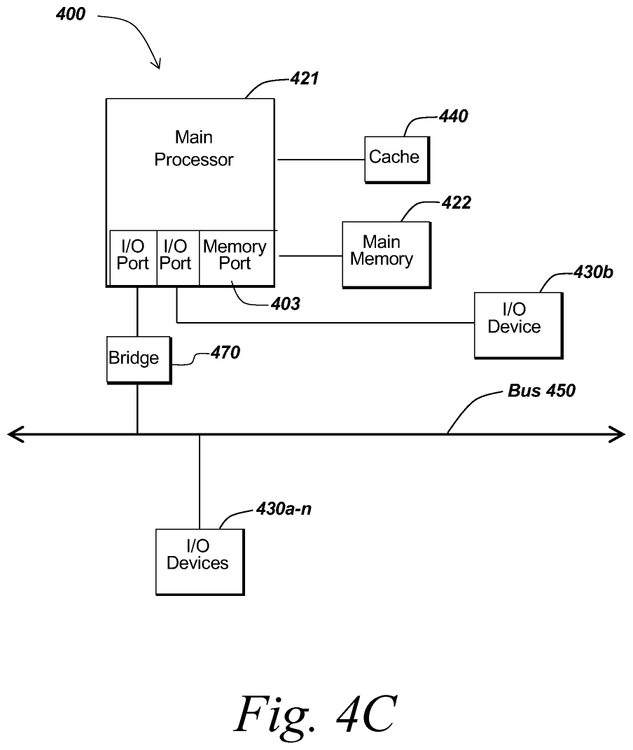

Referring now to FIG. 1, a block diagram depicts one embodiment of a system for automated identification of optimizable factors in multivariate processes. In brief overview, the system 100 includes a client computing device 102, a computing device 106a, data sources 106b-106n, a machine learning engine 110, an experimentation engine 112, and a database 120. The computing devices 102 and 106a-n may be a modified type or form of computing device (as described in greater detail below in connection with FIGS. 4A-C) that have been modified to execute instructions for providing the functionality described herein; these modifications result in a new type of computing device that provides a technical solution to problems rooted in computer technology, such as the problem of determining whether a data set is sufficient to identify one or more factors for optimization, acquiring access to one or more additional data sets if not, and executing one or more experiments to recommend a factor for optimization and a type of optimization to recommend.

The machine learning engine 110 may be provided as a software component. The machine learning engine 110 may be provided as a hardware component. The computing device 106a may execute the machine learning engine 110.

The experimentation engine 112 may be provided as a software component. The experimentation engine 112 may be provided as a hardware component. The computing device 106a may execute the experimentation engine 112.

The computing device 106a may include or be in communication with the database 120. The database 120 may be an ODBC-compliant database. For example, the database 120 maybe provided as an ORACLE database, manufactured by Oracle Corporation of Redwood Shores, CA. In other embodiments, the database 120 can be a Microsoft ACCESS database or a Microsoft SQL server database, manufactured by Microsoft Corporation of Redmond, WA. In other embodiments, the database 120 can be a SQLite database distributed by Hwaci of Charlotte, NC, or a PostgreSQL database distributed by The PostgreSQL Global Development Group. In still other embodiments, the database 120 may be a custom-designed database based on an open source database, such as the MYSQL family of freely available database products distributed by Oracle Corporation of Redwood City, CA. In other embodiments, examples of databases include, without limitation, structured storage (e.g., NoSQL-type databases and BigTable databases), HBase databases distributed by The Apache Software Foundation of Forest Hill, MD, MongoDB databases distributed by 10Gen, Inc., of New York, NY, an AWS DynamoDB distributed by Amazon Web Services and Cassandra databases distributed by The Apache Software Foundation of Forest Hill, MD. In further embodiments, the database 120 may be any form or type of database.

Although, for ease of discussion, the machine learning engine 110, the experimentation engine 112, the computing device 106a, and the database 120 are described in FIG. 1 as separate modules, it should be understood that this does not restrict the architecture to a particular implementation. For instance, these components may be encompassed by a single circuit or software function or, alternatively, distributed across a plurality of computing devices.

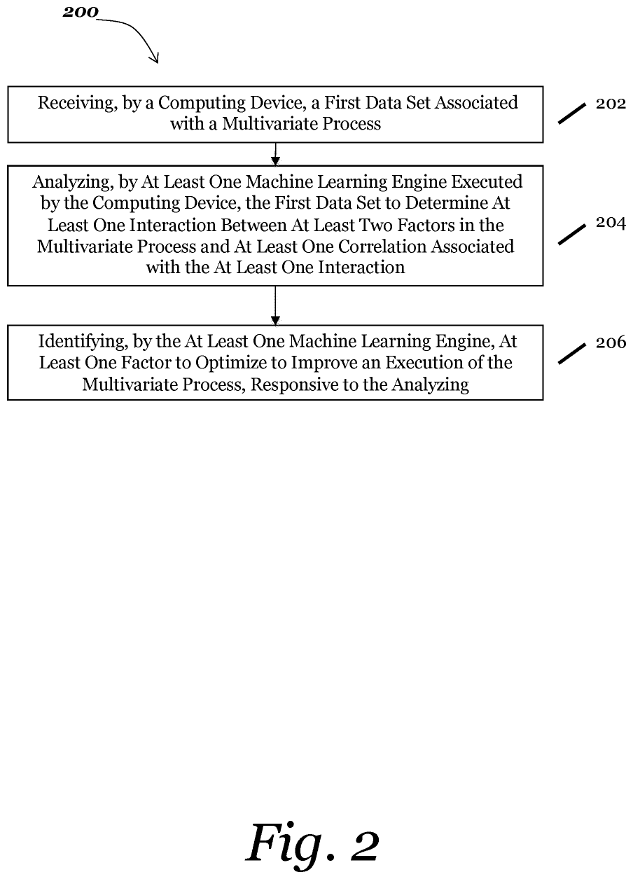

Referring now to FIG. 2, in brief overview, a flow diagram depicts one embodiment of a method 200 for automated identification of optimizable factors in multivariate processes. The method 200 includes receiving, by a computing device, a first data set associated with a multivariate process (202). The method 200 includes analyzing, by at least one machine learning engine executed by the computing device, the first data set to determine at least one interaction between at least two factors in the multivariate process and at least one correlation associated with the at least one interaction (204). The method 200 includes identifying, by the at least one machine learning engine, at least one factor to optimize to improve an execution of the multivariate process, responsive to the analyzing (206).

By way of example, and without limitation, in a multivariate process involving determining whether or not to enroll a particular patient in a healthcare intervention, the process may conventionally include steps such as determining via a set of clinical rules whether a patient is a high cost patient and, if so, having a case manager review patient data (including, e.g., healthcare guidelines, electronic health records for the patient, etc.), determining whether the patient creates enough of a risk of a high cost that it is worth engaging with the patient, executing one or more steps to establish contact with the patient and begin the intervention—for example, calling the patient, educating the patient as to an intervention, arranging for patient consent, enrolling the patient, and beginning the intervention that would minimize the risk of a high cost event. In this example, each step involves a cost that may or may not save the healthcare provider more money than the cost associated with a higher risk of the patient experiencing the high cost event (e.g., hospitalization)—and in some cases, a patient that is unable or unwilling to enroll in an intervention is both the patient most in need of the intervention and the costliest patient to attempt to assist. Attempts to address high cost events may require hiring additional case managers to decide which patients get contacted about interventions or hiring additional staff to establish contact with the patient and begin the intervention—the total cost of such intervention programs, therefore, may or may not be less than the cost of a hospitalization but the ability to determine whether the total cost of the intervention saved the healthcare provider any money or impacted the wellbeing of any patients may not be determinable for over a year. Conventionally, a human actuary or risk analyst may attempt to quantify the costs of each step but does not typically have access to the data required to quantify the costs and cannot begin to identify which factors matter for optimization because the case manager likely has limited ability to access and analyze all of the relevant data. As an example, an analyst may retrieve data showing salaries paid to staff hired to implement an intervention but may or may not be able to determine whether the patients that the staff reached and enrolled were patients who would otherwise have experienced expensive hospital stays or inexpensive hospitalization—and if a patient that enrolls in a program is typically a compliant patient that is likely to minimize health risks, the intervention may not be what prevented hospitalization but the patient's own behavior; such an analyst, even if they were able to apply a data-driven approach using conventional tools, does not have a tool available that can identify and retrieve the relevant data and perform the optimization. Moreover, a full optimization of the system would take into account the variance due to case managers' differing decisions; for example, one case manager may be less inclined to intervene on cases that she perceives as medium-risk than another case manager; yet another case manager may have different clinical judgment on the level of risk of a given patient. An analyst would not be able to track the difference in clinical and financial outcomes due to the assignment of individual patients (of which there may be tens or hundreds of thousands) to particular case managers (of which be hundreds or thousands). Finally, the analyst has no access or way to analyze counterfactuals, such as the impact of a potential change to clinical guidelines that might make more patients eligible for intervention, representing an increased opportunity for savings due to fewer adverse events, but would also increase operational cost due to the need for case managers to review a higher volume of cases, and might even have a counter effect of reducing attention to riskier patients due to higher case volume.

As another example in another industry, a system for managing portfolios of loans and tracking performance of loans to minimize the risk of outstanding loans does not conventionally have access to any functionality for identifying what information is required to identify the factors that should be optimized in order to increase efficiency not just in one part of a process but of the process as a whole. Conventional approaches for attempting to determine whether to modify a level of risk tolerance in granting loans simply do not include functionality for identifying what data is needed in order to identify the factors that need to be optimized and for testing through data-driven experimentation how optimization of one factor impacts the efficiency of the system as a whole. Other examples arise in processes as diverse as processes for assessing and acquiring real estate, financial management of value-based care contracts, and customer acquisition and sales lead management.

Regardless of industry, a human user may be able to identify and compute causal inferences in a process but the human mind is incapable of analyzing a multistep process where there is an expert system generating nondeterministic decisions and where statistical analyses may be needed to identify factors for optimization—and, as would be understood by one of ordinary skill in the art, conventional technology does not provide any solution to provide such analyses.

Referring now to FIG. 2, in greater detail and in connection with FIG. 1, the method 200 includes receiving, by a computing device, a first data set associated with a multivariate process (202). The computing device 106a may receive the first data set. In one embodiment, a user of the system 100 identifies a location from which the computing device 106a may retrieve the first data set; for example, by identifying a data source 106b-n, which may include computing devices on local or remote networks, databases, file stores, or other data sources. The computing device 106a may provide a user interface for display on a client computing device 102 with which a user may provide user input identifying one or more data sets or data sources. The user may provide an identification of a process for optimization that is associated with the first data set. The user may provide an identification of one or more constraints that limit available optimizations.

The method may include receiving an identification of at least one data source to be integrated into the system 100, which could be via API or, for a custom data source (e.g. a specific database implementation), could include execution of a manual mapping process. The method may include executing a GUI that allows the system to receive user input representing the specification of constraints, scenario modeling, definition of A/B experiments, etc.

The method may include mapping the identified at least one data source to a decision point in the multivariate process, resulting in a mapping between integrated data sources and either an agent in the multivariate process (e.g., decision/agent/case) or a step in the multivariate process.

The method 200 includes analyzing, by at least one machine learning engine executed by the computing device, the first data set to determine at least one interaction between at least two factors in the multivariate process and at least one correlation associated with the at least one interaction (204). The machine learning engine 110 may identify one or more steps in the multivariate process. The machine learning engine 110 may identify one or more factors impacting the execution of one or more steps. The machine learning engine 110 may leverage the mapping between data and parts of (or agents in) the multivariate process to do so.

The machine learning engine 110 may optimize decision making, given risk and cost constraints, without regard to industry. In a healthcare example, longer calls to patients on average might contribute to better assessment of the patient's risk and a better chance of enrollment in the program but also leads to increased operational costs and—assuming no increase in headcount—fewer calls overall, resulting in an opportunity cost for those patients who have not been called. To assess the impact on clinical and financial outcomes, the system therefore executes one or more components to calculate the risk to the marginal patient. As another example, the system may also need to determine whether optimize for other factors such as, without limitation, how the length of a call varies depending on the case manager, the patient's level of risk, the patient's willingness to engage (often inversely correlated with risk level), and so on. Therefore, in one embodiment, the method includes modeling the underlying multivariate process, and/or generating a joint probability distribution of the steps in the multivariate process. Such modeling may include execution of linear modeling (e.g., successive decision steps) with binary decision making (e.g., move to next step or not) and may result in a single primary outcome of interest (e.g., risk of adverse outcome). The Bayesian hierarchical approach may be well-suited here, but other approaches that focus on modeling the underlying mechanism (e.g. variational auto-encoders) may also be considered. Given such a model whose output is either a description of the joint probability or a simulation of samples from that probability, the system may then resolve the problem of optimization subject to constraints.

The machine learning engine 110 may first analyze data directly—for example, determining how a set of factors in a particular step of a process are distributed (e.g., a gamma or bell curve plotting out distribution of calls of a certain length of time) and determine whether there may be an optimization to make to a particular factor. This determination may be made, for example, by assuming a typical parametric distribution for relevant factors (e.g. durations, whether of phone calls or other events, empirically tend to follow a gamma distribution) and the correlation structure between them and fitting the appropriate statistical model. For certain known distributions, given the data on decision process (agents, decisions, outcomes, durations), parameters can be determined in closed form regardless of the number of samples, though the confidence intervals will depend on the amount of data. In other cases, numeric methods such as solution by quadrature or Markov chain Monte Carlo (MCMC) sampling can be used to determine the parameters by maximum likelihood estimator methods (MLE). As the number of factors and interactions increases, parametric fitting may no longer be appropriate due to compounding errors. In this case a hierarchical Bayesian approach may be taken, combining parametric distributions and sampling from those components that are not expressed in closed form. Other methods that can learn complex joint distributions and sample from them, such as variational auto-encoders, may also be used. In these cases, the machine learning engine 110 would be trained on a large dataset of data on decision processes, typically including thousands of samples or more. Using parameters from previously-trained models can help reduce the number of samples necessary for training on a new use case by providing a known starting point for optimization of the machine-learning algorithm, an approach known as “transfer learning”. Both Bayesian approaches and other approaches such as deep learning methods including variational-auto encoders, rely on scoring a large set of proposed parameters based on how well they represent the data and optimizing the parameters by making incremental changes to the proposed parameters, either by using MCMC methods whereby a small change to the parameters is proposed at random and accepted based on the resulting change in score, or using gradient-based approaches such as stochastic gradient descent (SGD) whereby changes to the parameters are based on the gradient of the scoring function. The optimization process is run iteratively for a large number of steps, as much as millions depending on the size of the dataset and the velocity of convergence. When the score is determined to have converged, for example by detecting that it is no longer changing appreciably, the model is tested on a holdout set known as the validation set. If the score on the validation set is determined to be inadequate, a new model may be trained or a new set of parameters proposed as the starting point. When training is complete, final performance is assessed on a separate holdout set known as the test set. The machine learning engine 110 may make at least one assumption regarding a possible interaction between at least two factors in the multivariate process as part of determining whether to identify a factor for optimization. The machine learning engine 110 may then analyze interactions between different steps in the process—for example, how length of time spent on a call impacts the number of patients successfully enrolled in an intervention or how the length of the call impacts the amount of staff needed, which may impact amount of money spent on wages. The machine learning engine 110 may apply Bayesian hierarchical modeling or other similar approaches to analyze how the inter-step interactions are distributed; based on analyzing the distribution, the machine learning engine 110 may then determine which factor in which steps impacts other steps in such a way as to warrant optimization of that factor. The machine learning engine 110 may generate a confidence interval associated with identified at least one factor to optimize. As an example, if increasing the length of time spent on a call with a patient by three minutes increases the number of patients successfully enrolled and if the number of patients successfully enrolled decreases the amount of hospital admissions in the patient population, the cost savings of hiring the staff to make the longer calls may be less than the amount saved from decreased hospital admissions, thus worth optimizing. Note that this example is about the average duration, but the system could also increase the time spent on the riskiest patients only, or increase the time spent by those case managers who tend to have shorter calls only, etc. Moreover, assuming a staffing constraint an increase in average call time may mean fewer patients can be called, the actual impact incurred on the marginal patient, not the average patient, may vary (i.e., there may be increased risk for those patients who would have been called under the first scenario but not the second), illustrating again the complexity of the factors under analysis and the limitation of conventional approaches.

As an example, the multivariate process may include identifying a number of patients eligible for enrollment in an intervention that improves the patients' quality of life and saves the healthcare provider a certain amount of healthcare cost and the multivariate process may include hiring a number of staff to call those patients—the number of patients and the amount of time needed to call each patient (which may including leaving one or more messages and making more than one call before reaching the patient) may impact the amount of time the staff needs to call each patient; as a result, attempting to optimize the amount of time needed to successfully call and enroll a patient may require an increase to the amount of salary needed for the staff, which may impact the amount of savings overall. Conversely, not optimizing the amount of time allocated to reaching each patient may mean that patients whose lives would be improved by the intervention and whose healthcare costs would be minimized by avoiding costly events are not enrolled in the intervention.

The method 200 includes identifying, by the at least one machine learning engine, at least one factor to optimize to improve an execution of the multivariate process, responsive to the analyzing (206). Executing the machine learning engine 110 in accordance with the methods and systems described herein may provide an improvement in functionality for identifying which of the various factors (e.g., number of patients to attempt to reach, amount of time allocated for reaching patients, number of staff hired and wages paid to reach the patients, etc.) impact total efficiency of the system and which of those factors to optimize to impact the overall efficiency. This determination may be made as follows. The machine learning engine 110 identifies the joint probability distributions of the various factors. This distribution may be represented in a parametric functional form if the various factors and the interactions between them are assumed to follow a known distribution such as gamma or multivariate normal. Alternatively in the absence of a representation of the distribution in closed form, the machine learning engine 110 can instead generate a large number of samples that follow the inferred joint distribution. In the former case, identifying a factor for optimization may be done by explicit calculation of the directional derivatives and selecting those factors for which the partial derivatives are positive. In the latter case, these derivatives can be estimated by applying small changes to individual factors, generating samples from the resulting joint distribution, and measuring the difference in the mean outcome. In either case, higher moments (e.g. standard deviation) can also be estimated to provide a confidence interval for the impact of implementing a change to the proposed factor. When the confidence interval is wide, there is not enough information to determine the impact of updating a given factor. In such case, an A/B test would be recommended to further evaluate the impact of the proposed change.

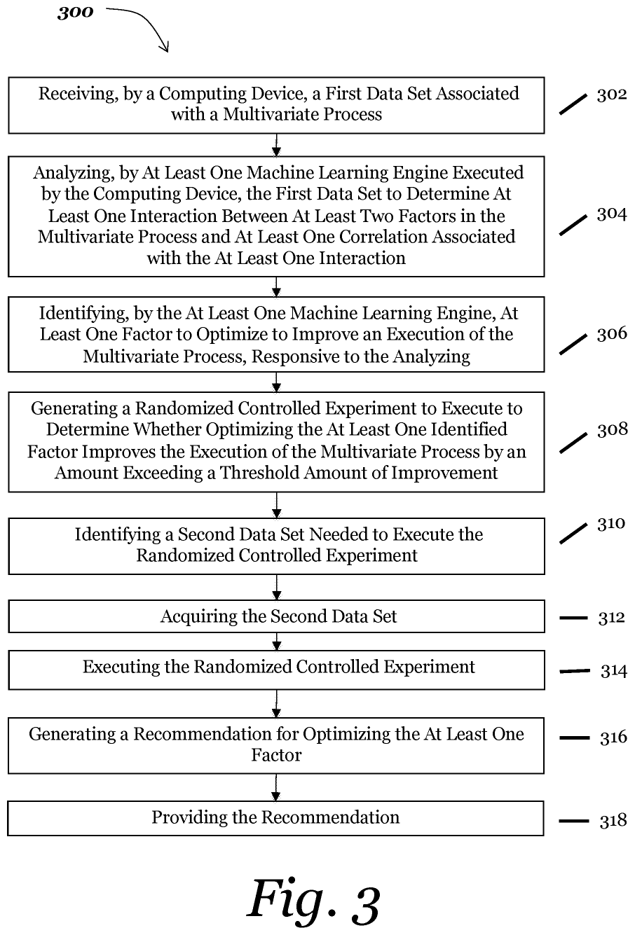

Having identified one or more factors for optimization, the system 100 may further analyze the factors and generate a recommendation as to how to optimize the identified factors. Referring now to FIG. 3, in brief overview, a flow diagram depicts one embodiment of a method 300 for automated identification of optimizable factors in multivariate processes. The method 300 includes receiving, by a computing device, a first data set associated with a multivariate process (302). The method 300 includes analyzing, by at least one machine learning engine executed by the computing device, the first data set to determine at least one interaction between at least two factors in the multivariate process and at least one correlation associated with the at least one interaction (304). The method 300 includes identifying, by the at least one machine learning engine, at least one factor to optimize to improve an execution of the multivariate process, responsive to the analyzing (306). The method 300 includes generating a randomized controlled experiment to execute to determine whether optimizing the at least one identified factor improves the execution of the multivariate process by an amount exceeding a threshold amount of improvement (308). The method 300 includes identifying a second data set needed to execute the randomized controlled experiment (310). The method 300 includes acquiring the second data set (312). The method 300 includes executing the randomized controlled experiment (314). The method 300 includes generating a recommendation for optimizing the at least one factor (316). The method 300 includes providing the recommendation (318).

As an example, a user may specify that the user wants to generate a financial forecast relating to implementation of a healthcare intervention—the user may have an intuition that the healthcare intervention has a positive impact on patient health by preventing hospitalizations and as a result also results in cost savings for the healthcare provider but the intuition and conventional mathematical approaches alone will not provide guidance as to how to create a budget to implement the intervention or to forecast various scenarios for the financial impact of the intervention. As another example, a manger of a portfolio of loans may be able to track performance on the loans and determine that there are a few outstanding loans of a certain age that have a higher risk than anticipated and have an intuition that a different level of risk tolerance is required for new incoming loan applications, but turning away new incoming loan applications comes with a risk of turning away low risk loans or high risk loans that have a high likelihood of getting paid off at a profit—again, conventional mathematical approaches do not provide an answer to whether or how to modify the level of risk in such a scenario. Therefore, the methods and systems described herein may include functionality not only for identifying a key factor that should be optimized—such as the level of risk tolerance or the number of staff to hire to implement a healthcare intervention—but may also define a randomized controlled experiment to execute in order to determine how to implement a specific optimization. For example, the system 100 may define an A/B test to execute to determine whether to increase a length of a patient phone call from seven minutes to 15 minutes or whether to hire three nurses or five nurses or how much to budget for salary.

Referring now to FIG. 3, in greater detail and in connection with FIGS. 1-2, the method 300 includes receiving, by a computing device, a first data set associated with a multivariate process (302). The computing device 106a may receive the first data set as described above in connection with FIG. 2 at (202).

The method 300 includes analyzing, by at least one machine learning engine executed by the computing device, the first data set to determine at least one interaction between at least two factors in the multivariate process and at least one correlation associated with the at least one interaction (304). The machine learning engine 110 may analyze the first data set as described above in connection with FIG. 2 at (204).

The method 300 includes identifying, by the at least one machine learning engine, at least one factor to optimize to improve an execution of the multivariate process, responsive to the analyzing (306). The machine learning engine 110 may identify the at least one factor as described above in connection with FIG. 2 at (206).

The method 300 includes generating a randomized controlled experiment to execute to determine whether optimizing the at least one identified factor improves the execution of the multivariate process by an amount exceeding a threshold amount of improvement (308).

The experimentation engine 112 may identify the randomized controlled experiment to generate by analyzing the role of the at least one identified factor in at least one step of the multivariate process and analyzing the role of at least one actor involved in the at least one step of the multivariate process and interacting with the at least one identified factor (i.e., by analyzing the factor at the decision/agent level). The experimentation engine 112 may use the mapping between the identified data source and the step in the multivariate process to analyze the originally received data and determine which changes to the original data source would result in an improvement to the execution of the overall process. In one embodiment, a single analysis of the original data and modeling of a proposed change will suffice to determine whether optimizing the at least one identified factor will improve the overall execution of the multivariate process (e.g. when optimizing changes to a risk cutoff threshold). In another embodiment, the experimentation engine 112 may execute multiple analyses to examine a plurality of features in the original data source and the impact of each of the plurality of factors on the multivariate process.

The method 300 includes identifying a second data set needed to execute the randomized controlled experiment (310). In some embodiments, the experimentation engine 112 determines that the original data set is insufficient to execute the randomized controlled experiment. By way of example, the experimentation engine 112 may execute multiple analyses to examine a plurality of features and those analyses may require analyses of one or more additional data sources. The method 300 includes acquiring the second data set (312).

The method 300 includes executing the randomized controlled experiment (314). Once a factor for optimization has been identified, the experimentation engine 112 may use new test cases (e.g., either actual, new incoming cases or simulated cases generated for the purposes of completing the randomized controlled experiment) are randomly allocated to two groups, called the “A” arm and the “B” arm; in some experiments, additional arms may be defined. The random allocation may further be stratified to ensure adequate balance between the two arms even for relatively small sub-populations that may be imbalanced in an unstratified random allocation. Each of the arms implements a different variant of the process (e.g., a variant of the identified factor). In a healthcare example, such a variant may include, for example, the implementation of a new clinical rule, a change to the population of patients allocated to a case manager, or a change to the number of times a case manager attempts to reach a patient. In many cases, only one arm will represent a change to the current process whereas the other arm is used as a control. The size of each arm is determined based on a power and sensitivity analysis based on the potential impact of the optimization to ensure that enough data is captured to accurately measure the impact of the experiment. The size and composition of each arm of the experiment may be updated dynamically in an adaptive fashion based on results observed up to a given point in time.

The method 300 includes generating a recommendation for optimizing the at least one factor (316). Once enough data has been collected, the experimentation engine 112 may assess the impact of the proposed variant by comparing the performance of the two arms according to particular metrics of interest such as overall cost or risk. Statistical estimation methods are used to assess the validity and uncertainty of the observed result. Such analysis may be carried for the full population or for various strata representing different subpopulations. If the impact is determined to be negative, null, or negligible, the method 300 may include generating a new randomized controlled experiment, whose definition may be guided by the results of the original experiment. If the impact is determined to be positive, the method 300 will include generating a recommendation to implement the variant represented by the optimized arm of the experiment, along with potential additional experiment to further optimize the results.

The method 300 includes providing the recommendation (318). By selecting a type of randomized controlled experiment to execute and providing functionality for confirming that the data necessary for executing the experiment is available or retrieving the necessary data if not already available and then analyzing the result of the experiment to determine how to optimize the previously identified factors, the systems and methods described herein provide data-driven recommendations for optimizing factors selected to satisfy threshold levels of optimization across multivariate processes. By abstracting workflows, cases, decisions, outcomes, and decisionmakers, the methods and systems described herein provide functionality for analyzing data used within a multivariate process to identify data input, categorized decision types, and outputs that can be optimized, selecting the one or more factors that are more likely (e.g., associated with a confidence interval that meets or exceeds a threshold level of confidence) to generate at least a threshold level of optimization across the process as a whole, thus providing a data-driven approach to identifying and optimizing factors in multivariate processes.

As an example, the methods and systems described herein may support financial management of value-based care contracts. In the conventional execution of value-based care (“VBC”) contracts, healthcare providers typically receive a fixed (“capitated”) fee per patient from an insurer (e.g., the government or a private payer), rather than being compensated by volume of services, which may incentivize healthcare providers to reduce costs. Financially speaking, such a system benefits from evaluating each patient in the way a system would evaluate a loan or insurance contract: the capitated fee is the premium but if the patient ends up being more expensive to treat than anticipated (e.g., due to an expensive acute inpatient admission), the provider may end up losing money on the contract. In practice, VBC contracts, either between providers and the government or between providers and payers, include many additional complex components to adjust risk, incentivize provisioning of high-quality services, allow for state-level adjustments and so on. Moreover, a large provider may manage multiple VBC contracts, each covering a population of thousands or tens of thousands of patients. Financially speaking, a provider's VBC business represents a complex portfolio of loans or bonds of different types, maturities, levels of exposure, complexity, and other factors. Therefore, implementing the methods and systems described above may provide an improved approach to evaluating the impact of one or more VBC contracts and to determining whether to accept one or more VBC contracts. The method 300 may allow for evaluation of an impact of at least one VBC contract in financial budgeting and forecasting and, optionally, result in a recommendation regarding a negotiation point to make in negotiating one or more VBC contracts. Execution of the method 300 may result in receiving at least one insight into the potential impact of changes in the demographic or clinical characteristics of the patient population on contract performance. Execution of the method 300 may result in receiving at least one recommendation regarding how to optimize performance of one or more clinical programs for a given VBC contract. Execution of the method 300 may result in receiving at least one recommendation regarding how to optimize an overall impact of one or more clinical and/or operational programs on a portfolio of VBC contracts as a whole. Therefore, the method 300 may include receiving a first data set associated with a multivariate process such as execution of at least one VBC contract to provide care for at least one patient within at least one constraint specified by the at least one VBC contract (such as, for example, cost); analyzing, by the at least one machine learning engine, the first data set to determine at least one interaction between at least two factors in the execution of a process specified by the at least one VBC contract, and identifying at least one factor to optimize to improve execution of the process specified by the at least one VBC contract. The method 300 may further include generating a randomized controlled experiment to execute to determine whether optimizing the at least one identified factor improves execution of the process by an amount exceeding a threshold amount of improvement, as described above. Alternatively, or in addition, instead of generating the randomized controlled experiment and gathering the data sets needed to execute the randomized controlled experiment and doing so, the method 300 may include identifying a level of risk of failing to exceed the threshold amount of improvement and generating a recommendation for mitigating the level of risk. Therefore, execution of the methods and systems described herein may provide additional visibility into how to quantify and/or hedge risks, generate recommendations for modifications to one or more contracts and/or designing new contracts that satisfy threshold levels of risk, and providing recommendations for execution of VBC contracts while providing increased financial visibility into those contracts.

In some embodiments, the system 100 includes non-transitory, computer-readable medium comprising computer program instructions tangibly stored on the non-transitory computer-readable medium, wherein the instructions are executable by at least one processor to perform each of the steps described above in connection with FIGS. 2-3

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment. However, the scope of protection is defined by the appended claims; the embodiments mentioned herein provide examples.

The terms “A or B”, “at least one of A or/and B”, “at least one of A and B”, “at least one of A or B”, or “one or more of A or/and B” used in the various embodiments of the present disclosure include any and all combinations of words enumerated with it. For example, “A or B”, “at least one of A and B” or “at least one of A or B” may mean (1) including at least one A, (2) including at least one B, (3) including either A or B, or (4) including both at least one A and at least one B.

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C #, JAVA, Python, Rust, Go, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Referring now to FIGS. 4A, 4B, and 4C, block diagrams depict additional detail regarding computing devices that may be modified to execute novel, non-obvious functionality for implementing the methods and systems described above.

Referring now to FIG. 4A, an embodiment of a network environment is depicted. In brief overview, the network environment comprises one or more clients 402a-402n (also generally referred to as local machine(s) 402, client(s) 402, client node(s) 402, client machine(s) 402, client computer(s) 402, client device(s) 402, computing device(s) 402, endpoint(s) 402, or endpoint node(s) 402) in communication with one or more remote machines 406a-406n (also generally referred to as server(s) 406 or computing device(s) 406) via one or more networks 404.

Although FIG. 4A shows a network 404 between the clients 402 and the remote machines 406, the clients 402 and the remote machines 406 may be on the same network 404. The network 404 can be a local area network (LAN), such as a company Intranet, a metropolitan area network (MAN), or a wide area network (WAN), such as the Internet or the World Wide Web. In some embodiments, there are multiple networks 404 between the clients 402 and the remote machines 406. In one of these embodiments, a network 404′ (not shown) may be a private network and a network 404 may be a public network. In another of these embodiments, a network 404 may be a private network and a network 404′ a public network. In still another embodiment, networks 404 and 404′ may both be private networks. In yet another embodiment, networks 404 and 404′ may both be public networks.

The network 404 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, a wireline network, an Ethernet, a virtual private network (VPN), a software-defined network (SDN), a network within the cloud such as AWS VPC (Virtual Private Cloud) network or Azure Virtual Network (VNet), and a RDMA (Remote Direct Memory Access) network. In some embodiments, the network 404 may comprise a wireless link, such as an infrared channel or satellite band. The topology of the network 404 may be a bus, star, or ring network topology. The network 404 may be of any such network topology as known to those ordinarily skilled in the art capable of supporting the operations described herein. The network may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client 402 and a remote machine 406 (referred to generally as computing devices 400 or as machines 400) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 402 may execute, operate or otherwise provide an application, which can be any type and/or form of software, program, or executable instructions, including, without limitation, any type and/or form of web browser, web-based client, client-server application, an ActiveX control, a JAVA applet, a webserver, a database, an HPC (high performance computing) application, a data processing application, or any other type and/or form of executable instructions capable of executing on client 302.

In one embodiment, a computing device 406 provides functionality of a web server. The web server may be any type of web server, including web servers that are open-source web servers, web servers that execute proprietary software, and cloud-based web servers where a third party hosts the hardware executing the functionality of the web server. In some embodiments, a web server 406 comprises an open-source web server, such as the APACHE servers maintained by the Apache Software Foundation of Delaware. In other embodiments, the web server executes proprietary software, such as the INTERNET INFORMATION SERVICES products provided by Microsoft Corporation of Redmond, WA, the ORACLE IPLANET web server products provided by Oracle Corporation of Redwood Shores, CA, or the ORACLE WEBLOGIC products provided by Oracle Corporation of Redwood Shores, CA.

In some embodiments, the system may include multiple, logically-grouped remote machines 406. In one of these embodiments, the logical group of remote machines may be referred to as a server farm 438. In another of these embodiments, the server farm 438 may be administered as a single entity.

As will be understood by those of skill in the art, in some embodiments, a computing device 400 may provide a virtualization environment. In such embodiments, the computing device 400 may include a hypervisor layer, a virtualization layer, and a hardware layer. The hypervisor layer includes a hypervisor that allocates and manages access to a number of physical resources in the hardware layer (e.g., the processor(s) and disk(s)) by at least one virtual machine executing in the virtualization layer. The virtualization layer includes at least one operating system and a plurality of virtual resources allocated to the at least one operating system. Virtual resources may include, without limitation, a plurality of virtual processors and virtual disks, as well as virtual resources such as virtual memory and virtual network interfaces. The plurality of virtual resources and the operating system may be referred to as a virtual machine. A hypervisor may provide virtual resources to an operating system in any manner that simulates the operating system having access to a physical device. A hypervisor may provide virtual resources to any number of guest operating systems. In some embodiments, a computing device executes one or more types of hypervisors. In these embodiments, hypervisors may be used to emulate virtual hardware, partition physical hardware, virtualize physical hardware, and execute virtual machines that provide access to computing environments. Hypervisors may include those manufactured by VMWare, Inc., of Palo Alto, California; the XEN hypervisor, an open source product whose development is overseen by the open source Xen.org community; the KVM hypervisor, an open source product whose development is overseen by the open source Linux community; HyperV, VirtualServer or virtual PC hypervisors provided by Microsoft, Amazon Nitro, Amazon Firecracker, or others. In some embodiments, a computing device executing a hypervisor that creates a virtual machine platform on which guest operating systems may execute is referred to as a host server. In some embodiments, a hypervisor executes within an operating system executing on a computing device. In one of these embodiments, a computing device executing an operating system and a hypervisor may be said to have a host operating system (the operating system executing on the computing device), and a guest operating system (an operating system executing within a computing resource partition provided by the hypervisor). In other embodiments, a hypervisor interacts directly with hardware on a computing device, instead of executing on a host operating system. In one of these embodiments, the hypervisor may be said to be executing on “bare metal,” referring to the hardware comprising the computing device. In some embodiments, the hypervisor controls processor scheduling and memory partitioning for a virtual machine executing on the computing device. In one of these embodiments, the hypervisor controls the execution of at least one virtual machine. In another of these embodiments, the hypervisor presents at least one virtual machine with an abstraction of at least one hardware resource provided by the computing device. In other embodiments, the hypervisor controls whether and how physical processor capabilities are presented to the virtual machine. In one embodiment, the guest operating system, in conjunction with the virtual machine on which it executes, forms a fully-virtualized virtual machine which is not aware that it is a virtual machine; such a machine may be referred to as a “Domain U HVM (Hardware Virtual Machine)”. In another embodiment, a fully-virtualized machine includes software emulating a Basic Input/Output System (BIOS) in order to execute an operating system within the fully-virtualized machine. In still another embodiment, a fully-virtualized machine may include a driver that provides functionality by communicating with the hypervisor; in such an embodiment, the driver is typically aware that it executes within a virtualized environment. In another embodiment, the guest operating system, in conjunction with the virtual machine on which it executes, forms a paravirtualized virtual machine, which is aware that it is a virtual machine; such a machine may be referred to as a “Domain U PV virtual machine”. In another embodiment, a paravirtualized machine includes additional drivers that a fully-virtualized machine does not include.

FIGS. 4B and 4C depict block diagrams of a computing device 400 useful for practicing an embodiment of the client 402 or a remote machine 406. As shown in FIGS. 4B and 4C, each computing device 400 includes a central processing unit 421, and a main memory unit 422. As shown in FIG. 4B, a computing device 400 may include a storage device 428, an installation device 416, a network interface 418, an I/O controller 423, display devices 424a-n, a keyboard 426, a pointing device 427, such as a mouse, and one or more other I/O devices 430a-n. The storage device 428 may include, without limitation, an operating system and software. As shown in FIG. 4C, each computing device 400 may also include additional optional elements, such as a memory port 403, a bridge 470, one or more input/output devices 430a-n (generally referred to using reference numeral 430), and a cache memory 440 in communication with the central processing unit 421.

The central processing unit 421 is any logic circuitry that responds to and processes instructions fetched from the main memory unit 422. In many embodiments, the central processing unit 421 is provided by a microprocessor unit, such as: those manufactured by Intel Corporation of Mountain View, CA; those manufactured by Motorola Corporation of Schaumburg, IL; those manufactured by Transmeta Corporation of Santa Clara, CA; those manufactured by International Business Machines of White Plains, NY; or those manufactured by Advanced Micro Devices of Sunnyvale, CA. Other examples include RISC-V processors, SPARC processors, ARM processors, processors used to build UNIX/LINUX “white” boxes, and processors for mobile devices. The computing device 400 may be based on any of these processors, or any other processor capable of operating as described herein.

Main memory unit 422 may be one or more memory chips capable of storing data and allowing any storage location to be directly accessed by the microprocessor 421. The main memory 422 may be based on any available memory chips capable of operating as described herein. In the embodiment shown in FIG. 4B, the processor 421 communicates with main memory 422 via a system bus 450. FIG. 4C depicts an embodiment of a computing device 400 in which the processor communicates directly with main memory 422 via a memory port 403. FIG. 4C also depicts an embodiment in which the main processor 421 communicates directly with cache memory 440 via a secondary bus, sometimes referred to as a backside bus. In other embodiments, the main processor 421 communicates with cache memory 440 using the system bus 450.

In the embodiment shown in FIG. 4B, the processor 421 communicates with various I/O devices 430 via a local system bus 450. Various buses may be used to connect the central processing unit 421 to any of the I/O devices 430, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 424, the processor 421 may use an Advanced Graphics Port (AGP) to communicate with the display 424. FIG. 4C depicts an embodiment of a computing device 400 in which the main processor 421 also communicates directly with an I/O device 430b via, for example, HYPERTRANSPORT, RAPIDIO, or INFINIBAND communications technology.

One or more of a wide variety of I/O devices 430a-n may be present in or connected to the computing device 300, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 423 as shown in FIG. 4B. Furthermore, an I/O device may also provide storage and/or an installation medium 416 for the computing device 400. In some embodiments, the computing device 400 may provide USB connections (not shown) to receive handheld USB storage devices such as the USB Flash Drive line of devices manufactured by Twintech Industry, Inc. of Los Alamitos, CA.

Referring still to FIG. 4B, the computing device 400 may support any suitable installation device 416, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 400 may provide functionality for installing software over a network 404. The computing device 400 may further comprise a storage device, such as one or more hard disk drives or redundant arrays of independent disks, for storing an operating system and other software. Alternatively, the computing device 400 may rely on memory chips for storage instead of hard disks.

Furthermore, the computing device 400 may include a network interface 418 to interface to the network 404 through a variety of connections including, but not limited to, standard telephone lines, LAN or WAN links (e.g., 802.11, T1, T3, 56 kb, X.25, SNA, DECNET, RDMA), broadband connections (e.g., ISDN, Frame Relay, ATM, Gigabit Ethernet, Ethernet-over-SONET), wireless connections, virtual private network (VPN) connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 400 communicates with other computing devices 400′ via any type and/or form of gateway or tunneling protocol such as GRE, VXLAN, IPIP, SIT, ip6tnl, VTI and VTI6, IP6GRE, FOU, GUE, GENEVE, ERSPAN, Secure Socket Layer (SSL) or Transport Layer Security (TLS). The network interface 418 may comprise a built-in network adapter, network interface card, PCMCIA network card, card bus network adapter, wireless network adapter, USB network adapter, modem, or any other device suitable for interfacing the computing device 400 to any type of network capable of communication and performing the operations described herein.

In further embodiments, an I/O device 430 may be a bridge between the system bus 450 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 400 of the sort depicted in FIGS. 4B and 4C typically operates under the control of operating systems, which control scheduling of tasks and access to system resources. The computing device 400 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, WINDOWS 8, WINDOWS VISTA, and WINDOWS 10 all of which are manufactured by Microsoft Corporation of Redmond, WA; MAC OS manufactured by Apple Inc. of Cupertino, CA; OS/2 manufactured by International Business Machines of Armonk, NY; Red Hat Enterprise Linux, a Linux-variant operating system distributed by Red Hat, Inc., of Raleigh, NC; Ubuntu, a freely-available operating system distributed by Canonical Ltd. of London, England; CentOS, a freely-available operating system distributed by the centos.org community; SUSE Linux, a freely-available operating system distributed by SUSE, or any type and/or form of a Unix operating system, among others.

Having described certain embodiments of methods and systems for automated identification of optimizable factors in multivariate processes, it will be apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method comprising:
receiving a first data set associated with a multivariate process;
analyzing, by at least one machine learning engine, the first data set to determine at least one interaction between at least two factors in the multivariate process and at least one correlation associated with the at least one interaction;
identifying at least one factor to optimize to improve an execution of the multivariate process, responsive to the analyzing;
generating a randomized controlled experiment to execute to determine whether optimizing the at least one identified factor improves the execution of the multivariate process by an amount exceeding a threshold amount of improvement;
identifying a second data set needed to execute the randomized controlled experiment;
acquiring the second data set;
executing the randomized controlled experiment;
generating a recommendation for optimizing the at least one factor; and
providing the recommendation.

2. The method of claim 1 further comprising identifying at least one assumption associated with a possible interaction between at least two factors in the multivariate process.

3. The method of claim 1 further comprising generating a confidence interval associated with the identified at least one factor to optimize.
